(19) United States
(12) Patent Application Publication
(10) Pub. No.: US 2016/0364734 A1
(43) Pub. Date: Dec. 15, 2016

(54) Integrated Computerized Sales Funnel System

(71) Applicant: Don Glanville, Scottsdale, AZ (US)

(72) Inventor: Don Glanville, Scottsdale, AZ (US)

(21) Appl. No.: 14/736,974

(22) Filed: Jun. 11, 2015

(51) Int. Cl. G06Q 30/02

(52) U.S. Cl. CPC G06Q 30/0201

(57) ABSTRACT

A proprietary sales funnel automation system that facilitates the sale of a product or service by systematically “walking” a prospect through an entire sales process. The system uses software as a service technology to manage the sales funnel system as well as the prospects that enter the system. The sales funnel system is preferably constructed using six key modules that are integrated with each other as well as with the other components, to permit an efficient exchange and use of information. These six modules include an introduction module, an application module, a response to application module, a detail presentation module, a financial module, and a closing module.

### CROSS REFERENCES TO RELATED APPLICATIONS

U.S. Provisional application for Patent No. 62/010,487, filed Jun. 11, 2014, with title “Integrated Computerized Sales Funnel System” which is hereby incorporated by reference. Applicant claims priority pursuant to 35 U.S.C. Par. 119(e)(i).

### STATEMENT AS TO RIGHTS TO INVENTIONS MADE UNDER FEDERALLY SPONSORED RESEARCH AND DEVELOPMENT

Not Applicable

### BACKGROUND OF THE INVENTION

1. Field of the Invention

The present invention is directed to a sales funnel automation system and, more particularly, to an automated presentation and sales system which facilitates the sale of an item or service by systematically “walking” a prospect through the sales funnel system and intelligently integrating into the system tools and controlled methods for communicating during the sales process.

2. Brief Description of Prior Art

The number of start-up ventures and home businesses are growing by large numbers daily. These entrepreneurs are looking for ways to generate cash flow and grow their businesses without the high risk and exuberant costs of trial and error generally associated with starting a new “bricks and mortar” business. These business owners and companies (“entrepreneurs”) for purposes of the present application may include inventors, network marketers, affiliate marketers, start-up ventures, large companies, and/or any entrepreneur interested in building and growing their business and brand.

Unfortunately most of these start-up ventures and small businesses (at an estimated rate of 95%) will fall due to lack of cash flow as a result of inadequate business systems, sales ability, marketing knowledge and poor implementation of proper business practices.

The only systems proven to offer an entrepreneur an insured level of success within the scope of business (us.gov success rate of 97%) is the franchise model.

The reason entrepreneurs can have success with the franchise model is because they don't have the ability to make many choices within the business model itself, where when a business is started outside of the structure of a franchise, there are a continued amount of questions to be answered and lessons to be learned at every level of the business' growth.

### Current Open Source Sales Systems:

To assist the entrepreneur, there exists “sales systems” to assist the entrepreneur in the sales process. Most known conventional sales systems for entrepreneurs have been implemented in a limited manner and are typically directed solely to a particular event, task or small subset of tasks in the overall sales process. Such systems are constructed by examining a particular sales event and by developing an automated tool to assist the salesperson confronted by the particular event. Such systems are incomplete, as they are individually developed without regard for the overall sales process, leaving the business owner to fill in the gaps in areas such as, but not limited to, qualifying prospects, sales techniques and supporting new customers.

Unfortunately, many entrepreneurs, are not trained in sales, and are therefore not qualified for “filling in these gaps.” The present system encourages entrepreneurs to focus on the areas they are qualified and the system to then fill in the gaps with real structure and automation.

Further, conventional sales automation systems are often developed by separate vendors and, as described above, the vendors develop the systems in consideration of only that portion of the overall sales process in which the sales automation system is to be used. As a result, the different systems are oftentimes incompatible with one another. This leads to an inefficient overall process and in many instances requires redundant steps and information stored in multiple locations for use by the various systems. The use of multiple, often incompatible sales tools throughout the sales process increases the costs associated with making the sale and lessens the likelihood of making the sale by diminishing the impact of the sales presentation and by failing to effectively use all of the information available to the entrepreneur.

In addition, once you have identified a sales process that is effective, it is important to be able to duplicate, not only for your own future sales activities with future prospects, but for the sales activities of other associates within your business. It should be understood that utilizing a process made up of multiple systems, each designed for a particular task, is more difficult to duplicate than a single automated sales system which facilitates the sale of an item or service by systematically “walking” a prospect through the entire sales process and intelligently integrating into the system tools and controlled methods for communicating during the sales process and then supporting that customer after the sale has been made.

Thus, there remains a need to provide a method and system for an automated sales system that systematically “walks” prospects through the entire sales process effectively from beginning to end. As will be seen from the subsequent description, the preferred embodiments of the present invention satisfy this objective, and, overcome these and other shortcomings of the prior art.

### SUMMARY OF THE INVENTION

The present invention is directed towards a technology by which a sales funnel automation system facilitates the sale of a product or service by systematically “walking” a prospect through an entire sales process. The system is a single solution all networked together, using software as a service technology that fills the gap many entrepreneurs can't get a grasp on. The present system effectively manages the sales funnel as well as the prospects during the sales cycle so that the entrepreneur doesn't get overwhelmed.

The present sales funnel system offers any business model a completely structured system that can best be compared to the structure often found in a franchise model. These systems of operation include; branding, bulk rate national advertising, automated sales & customer acquisition, distribution system, management module, customer support module, association platform and accounting system.

A main feature of the present application is the unique process in which the technology can systematically make high volume sales of various products at high and low price points without the need for professional sales people.

The present sales funnel system is constructed using six key modules which describe the sales cycle and processes occurring within it. All such modules are integrated with each other as well as with the other components, to permit an efficient exchange and use of information.

These six modules include (1) the prospect is first introduced to the sales system in which a product or service is being offered by some form of exposure, advertisement or referral.

The introduction page of the system for which a potential prospect is going to be introduced to a product or service is in place to provide a general explanation of the goods or services offered without full disclosure, details, features, pricing or demonstration of the product or service being sold, but provides enough information about what is being offered to encourage, and motivate the prospect to continue within the process.

This introduction page is designed to further qualify the prospect and determine a true level of interest for the product or service being offered within the sales system by requiring further action to be performed by the prospect.

On this introduction page, the prospect is required to enter certain information, such as their email address, cell phone or social network account information, for example, to continue on through the discovery process of the product or service of interest. Once the prospect has entered in this required information they are now cleared to continue onto the next step within the system called the application.

(2) An application module is used by the system to facilitate gathering of the prospect's responses to certain questions as well as gathering of other customer-specific information. The information may include data such as standard information about the prospect, including name and address. However, this component further allows the prospect to enter free-form responses to a number of questions asked within the application itself, and further allows the prospect to identify the prospect's relevant needs relating to the goods or services presented. One objective of the application module, that the prospect is clearly made aware of during the presentation, is that this gathering information process is used by the system in order to “qualify” the prospect for the goods or services the entrepreneur is presenting,
(3) Approximately 6 to 48 hours after the prospect submits its responses to the application, the system will notify the prospect that its application has been reviewed and accepted or denied. This time delay of 6 to 48 hours further complements the system's ability to retain prospects within the system by causing this “anticipation” with the prospect as to whether or not the system will “accept” the prospect following submission of responses to the questions/application.

(4) This module is designed to present a variety of information to the prospect using all media formats including text, graphic illustrations, motion, video, and sound to provide the presentation. The detail presentation module (as well as the other described modules) provides a similar function of effectively presenting a solution to the prospect's needs. The detail presentation not only explains the “why” for the subject product or service, but goes in to detail of “what” the product or service will do for the prospect.

(5) The financial module is designed to present a variety of information relating to the pricing of the subject goods or services offered. The prospect receives detailed information concerning the pricing associated with the goods or services offered.

(6) The closing component is integrated into the system to support the order creation and submission process, including configuring and pricing, at the point of sale. Closing is the dominant skill in module six of the sales cycle, and the system does it for the entrepreneur.

Another core component of the present invention is the back office system that includes a number of subsystems designed to further facilitate and support the sales process. The back office system includes a listing of all prospects that have entered the entrepreneur's funnel system, and clearly identifies for the entrepreneur where each prospect is within the sales funnel. The entrepreneur is able to access the back office system to maintain and manage the system and prospects entering the system. One critical tool includes associating a lead/prospect's cellular telephone number, email address or social network credentials with the entrepreneur who first introduced a particular product sold within the system to that prospect. It is anticipated that hundreds of thousands of entrepreneurs will be using the present system to promote goods and services. It remains critical to the integrity of the system that when an entrepreneur successfully introduces a product or service sold within the system to a prospect, and that prospect verifies their information with that entrepreneur's entry point into system, that the entrepreneur's work is not lost, and the prospect is “locked-in” with that entrepreneur for that particular product or service being sold.

Another key component is the configuration module which allows for the application of multiple sales funnels, for multiple goods and services, while being managed within the entrepreneur's back office system. For example, configuration module may be used to configure a sales funnel for a first product, and then a second sales funnel can be configured for a distinctly different product or service, and then a third sales funnel for another distinct product or service. Each of the three sales funnel systems operating independent of themselves in accordance with the present disclosure, where as potential prospects can enter in to other sales funnels for different products and services hosted by other entrepreneurs to eliminate the probability of saturation. The only way a previous entrepreneur can retain such prospects into new funnels presenting different products and services, is if the prospect enters into the new funnel an additional time independently and before entering into another entrepreneurs funnel for such products and services being sold within the new funnel.

### BRIEF DESCRIPTION OF THE DRAWINGS

FIG. 1 is a schematic drawing of computer architecture suitable for running the integrated computerized sales funnel system of the present invention.

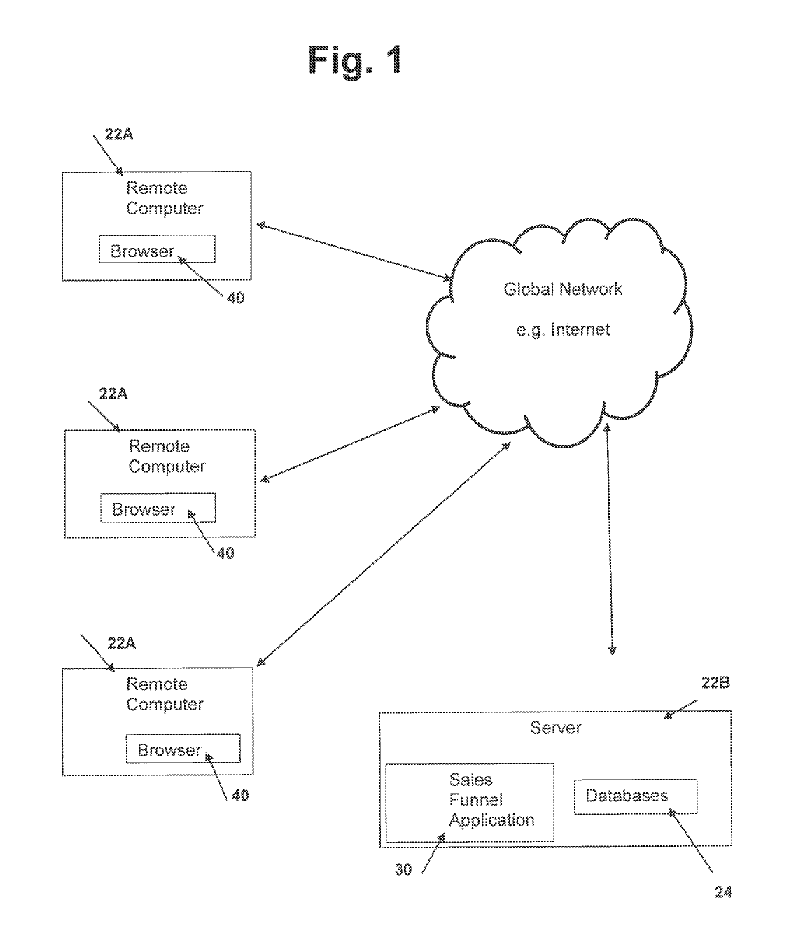

FIG. 2 illustrates the key modules of the sales funnel system of FIG. 1.

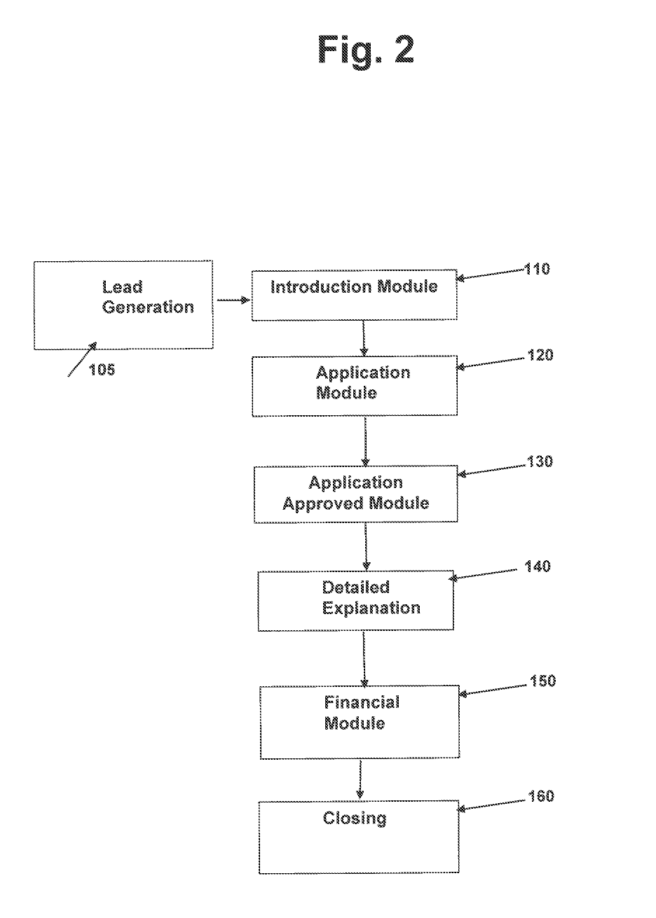

FIG. 3 is a conceptual diagram of the various components of the sales funnel system.

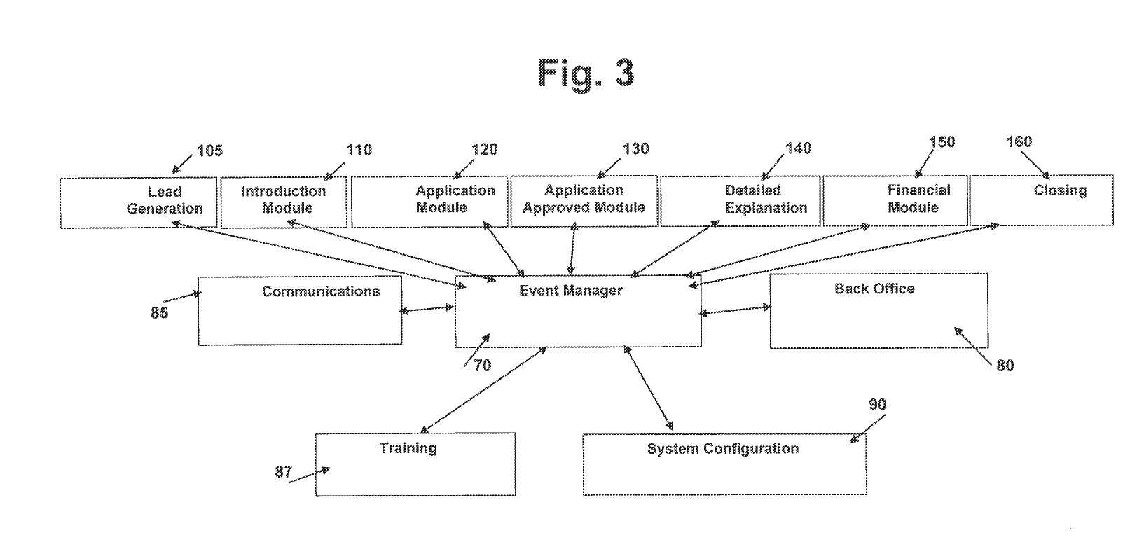

FIG. 4 illustrates an exemplary view of a stats page in the system's back office.

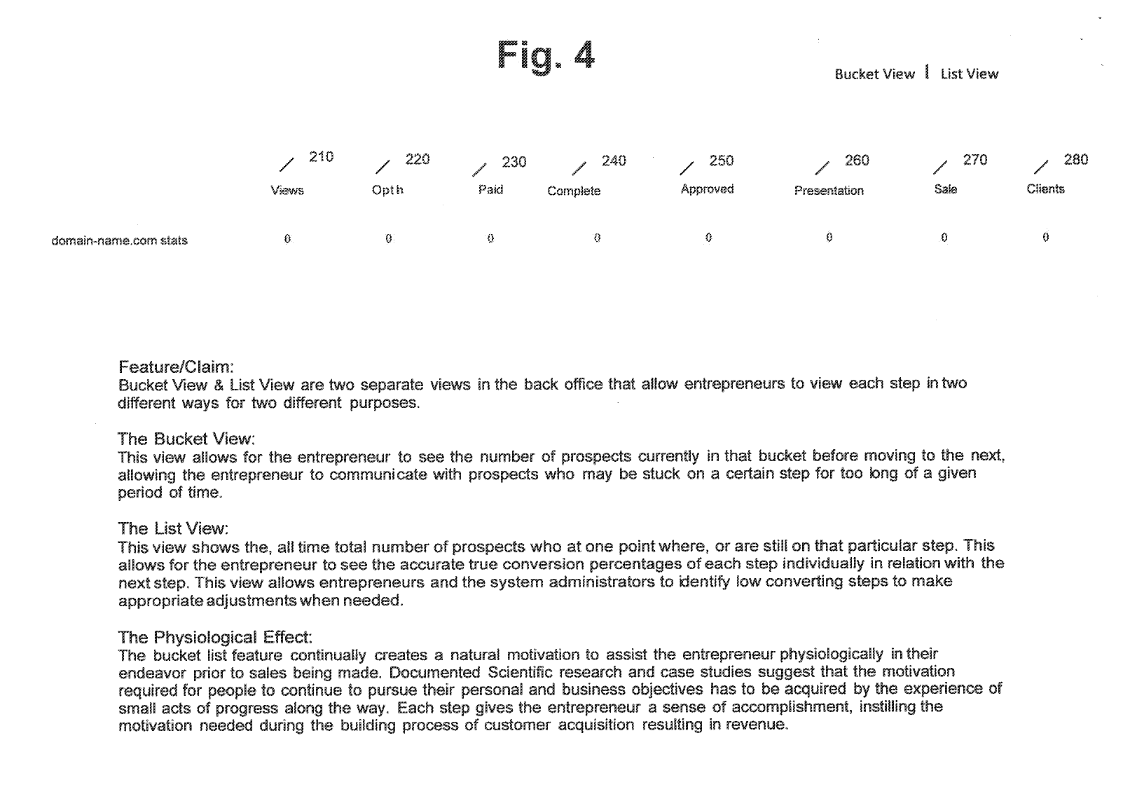

### DESCRIPTION OF THE PREFERRED EMBODIMENT

In accordance with the present invention, a method and system for an integrated computerized sales funnel system is disclosed. More particularly, the described method and system relates to a computer system having an automated presentation and sales system that facilitates the sale of an item or service by systematically “walking” a prospect through the sales process. The system further integrates system tools and controlled methods for communication with the prospect during the process. It is a single solution all networked together, using software as a service (SAAS) technology that fills the gaps many entrepreneurs can't get a grasp on.

Specifically, it will be noted in the following description that the present method and system discloses an efficient, automated presentation and sales system for the entire sales process. In addition, the present system not only manages activities during the sales process, but also provides tracking activities during the process. In short, the present system manages the prospects so that the entrepreneur doesn't get overwhelmed. In the broadest context, the method and system disclosed consists of components and steps configured with respect to each other so as to attain the desired objective.

Turning now to the Figures, wherein like reference numerals refer to like elements, there is illustrated a system and method for managing and tracking sales activities during an entire sales process. The system and method will be described in the general context of a computer network 20, as is well known in the industry, and computer executable instructions being executed by general purpose computing devices within the computer network 20. In this regard, the general purpose computing devices may comprise one or more remote computers 22A, and one or more application server computers 22B, hosting an integrated, activity-driven sales funnel application 30. The server computer 22B can also include one or more databases 24 for storing information, such as detailed information about sales opportunities, prospective purchasers and sales associates or affiliates. More details about the information that is stored in the databases are described in more detail below.

For purposes herein, “entrepreneur” may include network marketers, affiliate marketers, and/or entrepreneurs interested in building their home or small business. Entrepreneur can also include any industrial complex. And, reference to goods, products, or services represent whatever goods or services the entrepreneur represents.

To allow each of the remote computers 22A to access and utilize the sales funnel system, the software application 30 will preferably reside on the application server computer 22B. Further, it is preferable that users access the application 30 via an Internet browser 40 which acts as an interface between the application 30 and the operating system for the remote computer 22A. Although the operating system for the server computers 223 is preferably LINUX based, it should be understood that the local computer 223 could employ any one of the currently existing operating systems such as WINDOWS, MAC, OPEN SOURCE, etc. In addition, it should be appreciated by those with skill in the art that other applications besides the browser 40 may also be utilized to act as an interface between the application 30 and the remote computers 22A.

As would be appreciated by those of skill in the art, the computers 22A, 223 need not be limited to personal computers, but may include hand-held devices, multi-processor systems, microprocessor-based, or programmable consumer electronics, mini computers, mainframe computers, personal digital assistants, virtual reality, wearable technology, cellular telephones or the like depending on their intended end use within the system. To perform the particular task in accordance with the computer executable instructions, the computers 22A, 223 may include, as needed, a video adapter, a processing unit, a system memory, and a system bus that couples the system memory to the processing unit. The video adapter allows the computers 22A, 223 to support a display, such as a cathode ray tube (CRT), a liquid crystal display (LCD), a flat screen monitor, a touchscreen monitor or similar means for displaying textual and graphical data to a user (hereinafter collectively referred to as the “computer monitor or holographic virtual image”).

To connect the computers 22A, 22B within the computer network 20, the computers 22A, 223 may include a network interface or adapter. When used in a wide area network, such as the Internet, the computers 22A, 223 typically include a modem or similar device. The modem, which may be internal or external, is connected to the system bus via a serial port interface. It will be appreciated that the described network connections are exemplary and that other means of establishing a communications link between the computers 22A, 22B may be used. For example, the system may also include a wireless access interface that receives and transmits information via a wireless communications medium such as a cellular communications network, a satellite communications network, or another similar type of wireless network.

For populating and managing the databases 24, the present system utilizes applications and utilities known in the art. Similarly, the system includes means known for intelligently integrating and updating the system's databases 24 to recognize events occurring throughout each phase of the sales process.

For maintaining the security associated with the application 30 and databases 24, a unique login may be maintained for each user/entrepreneur, as will be further described. As should be understood, the login may be used to control the access privileges for various levels of users. In addition, each login may require a username and password. For security purposes, the usernames and passwords may be kept separately for each user that is accessing the application 30. To gain access to the application 30, the user must access the correct login page and enter the proper username and password. This login page access is obtained via a unique URL address assigned to the user/entrepreneur. It should be appreciated that different login procedures may be employed, which are well known in the industry, on an as-needed basis. In this regard, the system further includes means for handling administrative functions such as setting user passwords, managing default settings, performing data processes, etc.

A further core process component of the preferred system, is the prospect retention component that is generally included in each module of the sales system. This retention component assists the system, and the entrepreneur, in retaining a prospect, and is accomplished through processes that ensure a prospect remains interested, curious, and intrigued with the information forthcoming.

The present invention provides a model that encompasses a preferred sales cycle. The model encompasses all aspects of the sale cycle including events and interactions that occur within it. The present system is a fully integrated sales automated system in which each step or module of the entire system is integrated with each other module of the system 30 to intelligently form a complete sales tool. Exemplary components of a tool designed to support a complete sales process will be illustrated. As such, the present system is made up of a number of different modules which relate to the multiple phases of the sales process.

The sales model provided herein describes what happens in a sales cycle in a way that can be successfully modeled in a computer-based sales automation system. During the sales cycle, numerous interactions occur between the system and the prospect as part of the marketing and selling process. A large component of the selling process is dependent on human interactions, which is difficult to model in the computer. However, as will be described, the present invention overcomes this difficulty by incorporating strategic points of interaction as a part of the process.

There is another component of selling, however, that is dependent on well-established techniques and rules that have been developed and proven over many years. The sales model used in the present invention models the selling process using principles more properly characterized using these well-established techniques and rules.

The application's 30 model is constructed using six key modules which describe the sales cycle and processes occurring within it. All such modules are preferably integrated with each other as well as with the other components, to permit an efficient exchange and use of information. These six modules are:

### 1. Introduction

The sales cycle has a beginning and an end. The beginning of the sales cycle is defined at the point of time when the prospect enters the system by linking to the entrepreneur's unique URL. Potential prospects may be notified 105 of the present system and directed to the entrepreneur's URL by various means, for example, automated systems designed to attract interested prospects such as database marketing, electronic advertising, electronic mailing, etc. Such a process can be fully automated in accordance with parameters set by the entrepreneur using the system. Regardless, the lead generation component used, this point of entry is expressly defined by the system, and the system notifies the entrepreneur when a prospect enters the system.

The prospect is first introduced 110 to the product or service by viewing a page giving a very general description. As discussed, the page uses well-established techniques and rules that can be referred to as the “science of selling.” The introduction presentation 110 not only provides a general explanation of the goods or services offered, but also provides information about the overall sales process that encourages, and motivates the prospect to continue within the process.

The introduction presentation 110 places entrepreneurs in a position, regardless of their experience, and regardless of what they know, to give a professional, and success-proven introduction to the goods and services offered.

It takes both experience and time for an entrepreneur to test and master an effective initial sales introduction that will cause the prospect to act the way the system wants—to want more information and continue through the sales process. The first aspect of the present system eliminates the entrepreneur from having to learn and take time learning these important sales principles.

In the introduction aspect, the prospect is asked to verify the prospect's identity by entering his/her name and additional information, such as a working cellular phone number, email address or social network credentials. Once the prospect has entered his/her name and, form of contact, the system will immediately digitally send the prospect a digital passcode using the form of contact given. Contemporaneous with sending the digital passcode, the system displays on the prospect's computer monitor a field for the prospect to enter the sent passcode.

Once the prospect enters the passcode, the prospect is then given access to the second aspect of the sales cycle.

This step of requiring the prospect to verify its information by entering a name and a valid form of communication, and then requiring the prospect to enter the sent passcode in order to continue to the next step of the sales cycle, gives an indication as to how serious, or not, the prospect is, and further gives the entrepreneur a means to directly contact the prospect, when desired, using SMS texting, email, mailed post card or social network. Further, with the system's multi medium auto-responder, the system can now periodically send messages to the prospect encouraging the prospect, when needed, to continue through the sales cycle.

### 2. Application

There are certain questions that are routinely asked of a prospect during a face-to-face meeting. The application module prompts for this information by asking specific questions of the prospect, as well as other information that is part of the sales environment. An objective of the application module, that the prospect is clearly made aware of during the presentation, is that this gathering information process is used by the system in order to “qualify” the prospect for the goods or services the entrepreneur is presenting.

The application module 120 is used by the system to facilitate gathering of the prospect's responses to these questions as well as gathering of other customer-specific information. The information may include data such as standard information about the prospect, including name and address. However, this component further allows the prospect to enter free-form responses to a number of questions asked the prospect, and further allows the prospect to identify the prospect's relevant needs relating to the goods or services presented.

In particular, the application module 120 is where the entrepreneur finds out the details of the prospect's requirements, needs and motivations. Also, relevant background of the prospect may be established, including for example, whether the prospect is willing to make a purchase, and, does the prospect have sufficient funds to buy the goods or services offered.

In the application module 120, probing is the dominant skill used in this module in order to obtain relevant information relating to the prospect. In this regard, the prospect is encouraged to not only provide the requested information, but to explain in further detail the reason and motivation for the particular response.

It should therefore be understood that this second component 120 of the present invention causes further human interaction between the system and the prospect. And, this step of requiring the prospect to complete the application gives further indication as to how serious, or not, the prospect is. The quantity and quality of the information gained by the prospect in this module is an indicator as to the prospect's level of commitment to the system.

In this module 120, the prospect is instructed that once the completed application is submitted and received (by the entrepreneur), the system will review the prospect's responses in order to determine whether the goods or services being presented is right for the prospect, and most importantly, whether the prospect is right for the goods and services being offered.

To assist in determining whether a prospect is approved or not, the application component further includes analysis means for electronically reviewing certain responses given by the prospect to the questions asked. The entrepreneur, for example, may supply a range of acceptable responses for any given question asked such that the system can automatically reject any application when the response is outside such range.

There is an intentional time delay between 6 and 48 hours between when the prospect submits its responses to the application and when the system responds back to the prospect. This time delay further complements the system's ability to retain prospects within the system by causing this “anticipation” with the prospect as to whether or not the system will “accept” the prospect following submission of responses to the questions/application.

### 3. Application Approved

Approximately 6 to 48 hours after the prospect submits its responses to the application, the system will notify 130 the prospect that its application has been reviewed and accepted. During that 6 to 48 hour period, the system will preferably communicate with the prospect to advise that its application is “pending” and a decision to the application will be delivered soon. Such communications to the prospect are preferably via SMS texting, but can also be delivered via email, social network or post card. Once the prospect has received communications 130 that its application has been approved, the prospect will then receive further instructions on how to access the next module in the sales process. In particular, the prospect will receive the entrepreneur's URL to the next presentation module in the sales cycle. It should be understood that the prospect will not be directed to the next module unless the prospect submitted the appropriate responses to the application questions in the application module.

### 4. Detailed Explanation

Even the most effective prospect solutions will not be sold unless properly presented to the prospect. This module does that. The presentation module 140 provides highly automated presentation generation which draws upon information obtained from other modules and components of the system. The module 140 is designed to specify, organize and create a high-quality, interactive presentation based upon known information of prospects, canned information about the product or service offered, as well as any other information which may be imported into the sales system.

The prospect is again introduced to a series of informative pieces of information, to assist the entrepreneur by electronically giving a detailed presentation to the prospect and prepare a proposal for the prospect which reflects the presentation. This module 140 is designed to present a variety of information to this prospect using all media formats including text, graphic illustrations, motion, video, and sound to provide the presentation. The prospect not only receives detailed information concerning the goods or services, but may receive information related to competitive comparisons, giving the system the ability to present the entrepreneur's product or service information side-by-side with a competitor's information.

The detail presentation module 140 (as well as the other described modules) provides a similar function of effectively presenting a solution to the prospect's needs. The detail presentation 140 not only explains the “why” for the subject product or service, but goes in to detail of “what” the product or service will do for the prospect. The presentation module 140 converts the proposed solution to the prospect's needs into an effective presentation for use.

Again, detailed explanation module 140 provides an effective presentation to the sales process without a need for being face-to-face with the final decision maker.

At the completion of the detail presentation, the presentation media preferably displays a digital passcode and further displays on the prospect's computer monitor a field for the prospect to enter the displayed passcode.

Once the prospect enters the passcode, the prospect is then given access to the fifth module of the sales cycle. This step of requiring the prospect to enter the displayed passcode in order to continue to the next step of the sales cycle, gives further indication as to the commitment of the prospect

### 5. Financial Explained

During this phase 150 of the process, the system generates revenue for the entrepreneur by committing a prospect to a specific purchase, i.e., converting the prospect “lead” into a purchasing customer. This automated module 150 efficiently performs its function during this important phase of the sales process.

This financial module 150 is designed to present a variety of information relating to the cost of the goods or services offered. The financial presentation 150 only explains the various plans and pricing. The prospect is not asked to place an order during this aspect of the sales funnel cycle. At the completion of the financial presentation, the prospect is then given access to the sixth and final module of the sales cycle.

### 6. Closing Module

The closing component 160 is integrated into the system to support the order creation and submission process, including configuring and pricing, at the point of sale. In this manner, the present system automatically converts a prospect “solution” to a purchasing need.

The goal in closing 160 is to obtain a prospect commitment, once all issues have been addressed successfully, and the prospect has viewed all the presentations. Closing can only proceed when the prospect has learned enough about the entrepreneur's product or service in order to make an intelligent decision. Closing is the dominant skill in module six of the sales cycle, and the system does it for the entrepreneur.

### Core Components of the System

Event Manager: Each of the various components of the present system are communicatively coupled to an event manager 70. The various components of the system communicate with the event manager 70 using respective application programming interfaces. The event manager 70 intelligently controls the flow of data and other information through the system. For example, data required by or input received through one of the components as described will be handled by the event manager 70 to retrieve or store the data from and to a database, and further direct the prospect through the sales funnel system.

The event manager 70 provides intelligent integration of the components of the system 30. The event manager 70 recognizes events occurring in the system 30 and determines, on the basis of the event and the context in which the event occurs, what if any other action or operations should be carried out by the system. If actions are necessary, the event manager 70 notifies the appropriate component of the needed action, grants the component access to any needed data or other information and instructs the component to carry out the operation.

Back Office: A back office system 80 is further linked to the event manager 70. And, the event manager 70 further handles information processed in the back office system 80. The event manager 70 intelligently integrates the various components of the back office system 80. The back office system 80 includes a number of subsystems designed to further facilitate and support the sales process. The back office 80 allows an entrepreneur to manage the administration of prospects, and includes tools to define various aspects of the marketing system including, but not limited to, security rules, passwords, marketing tools, and support and training. Equally important, the back office system 80 includes a listing of all prospects that have entered the entrepreneur's system, and may include graphical images to clearly identify for the entrepreneur where each prospect is within the sales funnel 30.

The entrepreneur is able to access the back office system 80 to maintain and manage the system and prospects entering the system. One critical tool includes associating a lead/prospect's contact information with the entrepreneur who first introduced the system to that prospect. In this manner, prospects that are directed to an entrepreneur's unique URL, and verifies their contact information with that entrepreneur's system cannot then later enter the sales funnel of another entrepreneur's system offering the same goods or services. As a result, prospects that verify their information with an entrepreneur's system, are “locked-in” with that entrepreneur.

It is anticipated that hundreds of thousands of entrepreneurs will be using the present system to promote goods and services. It remains critical to the integrity of the system that when an entrepreneur successfully introduces the system to a prospect, and that prospect verifies their information with that entrepreneur's system, that the entrepreneur's work is not lost, and the prospect is, as discussed, “locked-in” with that entrepreneur.

As earlier discussed, the back office not only identifies the prospects that have entered the entrepreneur's funnel system, but also clearly identifies for the entrepreneur where (what module) each prospect currently is in the sales funnel.

The back office system 80 includes a “Quick Stats” page which identifies: (1) “Views” column 210—this area is populated with the total number of prospects that viewed the webpage associated with the entrepreneur's unique URL. (2) “Opt-in” column 220—this area is populated with the total number of prospects that verified their information by entering his/her name and contact information into the system. (3) “Paid column 230—the system may require, preferably at the point of submitting its completed application, a prospect to pay a minimal processing fee at the time of the application process. The fee is preferable minimal (less than $100 for example) but further gauges how serious the prospect is to the sales process. (4) “Complete” column 240—opportunities reside within the Complete column when the prospect has completed the application by responding to a number of questions, and submitted the prospect's responses to the system for consideration. (5) “Approved” column 250—this area is populated with the total number of prospects that have submitted their responses to questions in the application module, and have received notification from the system that the application has been reviewed and accepted. (6) “Presentation” column 260—opportunities reside within the Presentation column when the prospect has entered the detail explanation module and is presently reviewing presentation literature or a series of literature, that provides detailed information concerning the goods or services. (7) “Sale” column 270—opportunities reside within the Sale column only if a prospect has completed modules 1-5 and are currently in the sixth and final closing module. (8) “Clients” column 280—this area is populated with prospects who have elected to purchase the subject goods or services.

Communication/Interaction: In any given sales cycle, a certain number of critical customer interactions should occur. Throughout the sales cycle of the present invention, interaction 85 will occur between the entrepreneur and the prospect. The present invention specifies for the entrepreneur when these actions should occur, in which module, and at which point in that module, and further includes selectively timed SMS text, email, social network or post card auto-responder messages that are sent to the prospect throughout the sales funnel cycle. This information of what messages to send, and when to send them, can be determined using past experience and expert knowledge and is developed in advance for a particular sales opportunity by the system.

The first interaction 105 is the one that led to the prospect's discovery of the sales situation. This often involves online interaction where the prospect was searching online for the goods or services being offered, or, responded to an online advertisement of the entrepreneur's goods or services.

Next, the prospect is introduced 110 to the product or service by viewing the introduction page giving a very general description. This should occur immediately after the initial interaction.

Once the prospect has completed the verification step, and entered his/her name and contact information into the system, the system may interact with the prospect with an messages relating to the product or service. Again, this message is made in the very early stages of the probing phase.

The next interaction 120 with the system, the prospect is asked to complete the application where the prospect is asked to further interact and respond to a number of questions.

Once the prospect has completed the application and submitted its responses through the system, there is a time delay of approximately 6 to 48 hours before approval 130 and entering the next phase of the sales funnel.

Next comes a detailed explanation 140 of the product or service being offered. This again involves a presentation using a combination of text, graphic illustrations, motion, video, and sound. And, during this module, as well as the other modules, the system, or the entrepreneur may contact the prospect preferably using the contact information provided.

Immediately after the detailed explanation, a media explaining the financial 150 considerations, i.e., the pricing of the goods and services is explained. Also, the various purchasing options are further explained to the prospect.

Once the cost of the goods and services is explained, the closing phase 160 begins.

The final prospect interaction during step 160 is where the prospect tells the system, and the entrepreneur, whether or not it has chosen to purchase the offered goods or services.

Training: The system further includes a training component 87. The training component includes a system training module, a product training module, a skills training module, etc. The system facilitates integrated sales training in three key areas: product knowledge, sales skills and system usage. Each of the training components within the system are computer based training modules which present pre-built computer-based training courses to the entrepreneur.

Configuration Module: The configuration module 90 is comprised of multiple engines, and various other subcomponents, each optimized for a particular portion of the configuration process. The configuration module 90 is supported by a data manager and editor provided in the data tools subsystem of the back office system 80. The configuration module 90 importantly allows for the application of multiple sales funnels, for multiple goods and services, while being managed within the entrepreneurs back office 80.

Once a product or service funnel is configured, the configuration module 90 may be used to carry out performance of the funnel system, separately, for that particular product or service. For example, configuration module 90 may be used to configure a sales funnel for a first product, and then a second sales funnel can be configured for a distinctly different product or service, and then a third sales funnel for another distinct product or service. Each of the three funnel systems operating in accordance with the present disclosure. And, the back office system 80 separately managing all three sales funnels as disclosed above.

Although the description above contains many specificities, these should not be construed as limiting the scope of the invention but as merely providing illustrations of some of the presently preferred embodiments of this invention. Thus the scope of the invention should be determined by the appended claims in the formal application and their legal equivalents, rather than by the examples given.

I claim:

1. A sales funnel system model comprising:
an introduction module,
an application module,
a response to application module,
a detail presentation module,
a financial module, and
a closing module.

2. The system as recited in claim 1, wherein there is an approximate 6 to 48 hour delay after a prospect submits a response in the application module.

3. The system as recited in claim 2, wherein the application module includes a payment component.

4. The system as recited in claim 1, further including a back office system.

5. The system as recited in claim 4, wherein said back office system includes a listing of all prospects that have entered an entrepreneur's sales funnel system, and graphical images to clearly identify for the entrepreneur where each prospect is within the sales funnel.

6. The system as recited in claim 5, wherein said back office system includes means to lock-in a prospect with the entrepreneur's sales funnel system.

7. The system as recited in claim 6, further including a configuration module.

8. A sales funnel system model comprising:
an introduction module,
an application module, and
a response to application module.

9. The system as recited in claim 8, wherein there is an approximate 6 to 48 hour delay after a prospect submits a response in the application module.

10. The system as recited in claim 9, further including a detailed presentation module.

11. The system as recited in claim 10, further including a financial module.

12. The system as recited in claim 11, further including a closing module.

13. The system as recited in claim 12, further including a back office system.

14. The system as recited in claim 13, wherein said back office system includes a listing of all prospects that have entered an entrepreneur's funnel system, and graphical images to clearly identify for the entrepreneur where each prospect is within the sales funnel.

15. The system as recited in claim 14, wherein said back office further includes means to lock in a prospect with the entrepreneur's funnel system.

16. The system as recited in claim 15, further including a configuration module.
